(19) United States
(12) Patent Application Publication
(10) Pub. No.: US 2016/0110792 A1
(43) Pub. Date: Apr. 21, 2016

(54) Method and System for navigating searching for Blood Transfusion Products

(71) Applicant: AMANDA FRANSWAH, Duluth, GA (US)

(72) Inventor: AMANDA FRANSWAH, Duluth, GA (US)

(21) Appl. No.: 14/519,337

(22) Filed: Oct. 21, 2014

(51) Int. Cl. G06Q 30/06

(52) U.S. Cl. CPC G06Q 30/0627

(57) ABSTRACT

A new and improved method and system for navigating/searching for blood transfusion products is described herein.

### BRIEF DESCRIPTION OF THE FIGURES

For a more complete understanding of the present invention, including its features and advantages, reference is now made to the detailed description of the invention taken in conjunction with the accompanying drawing in which:

FIGS. 1-5 describe the Product Look-up software currently available to search ISBT 128 codes and Product descriptions. Similar such search criteria is currently available by various vendors. FIGS. 6 and 7 are used for the purposes of describing the current invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

International Society of Blood Transfusion (ISBT) 128 Product description codes and Product Look up software are available to Facilities and Vendors who are registered with the International Council for Commonality in Blood Bank Automation (ICCBBA). Consequently, the ICCBBA, in association with World Health Organization (WHO), manages, develops, and licenses ISBT 128.

The ISBT has approved the use of ISBT 128 labelling system internationally for Blood Products, Cellular Therapy Products, Organs, and Tissues. The use of this labelling system allows for Specific products codes and unique Donor Identification Number (DIN) that can be traced anywhere in the world.

As described in the ICCBBA website and as Industry professionals are aware of, selecting an ISBT 128 product code can be daunting task. The ICCBBA's Product Description Code database currently consists of over 8000 codes for Blood, Cellular Therapy, Tissues and Organs. However, for all registered users, the ICCBA provides Product Look up software, which allows for the search of product codes.

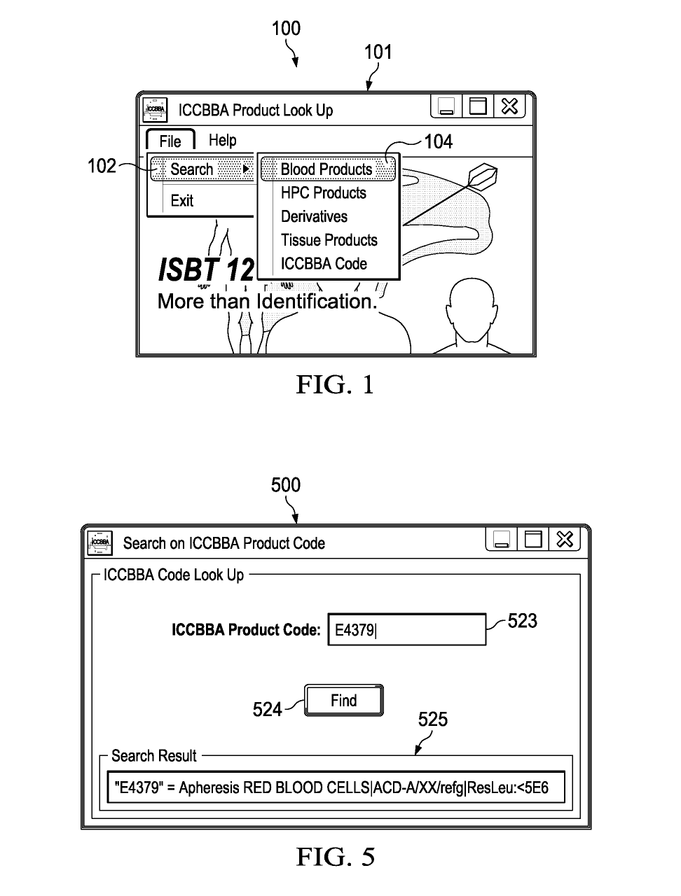

The Product Look Up software allows users to select Blood Products, HPC Products (Cellular Therapy), Derivatives and Tissue Products (Tissues/Organs) as shown in FIG. 1. Once the major category is selected, further Search filters are used to search for desired ISBT 128 codes.

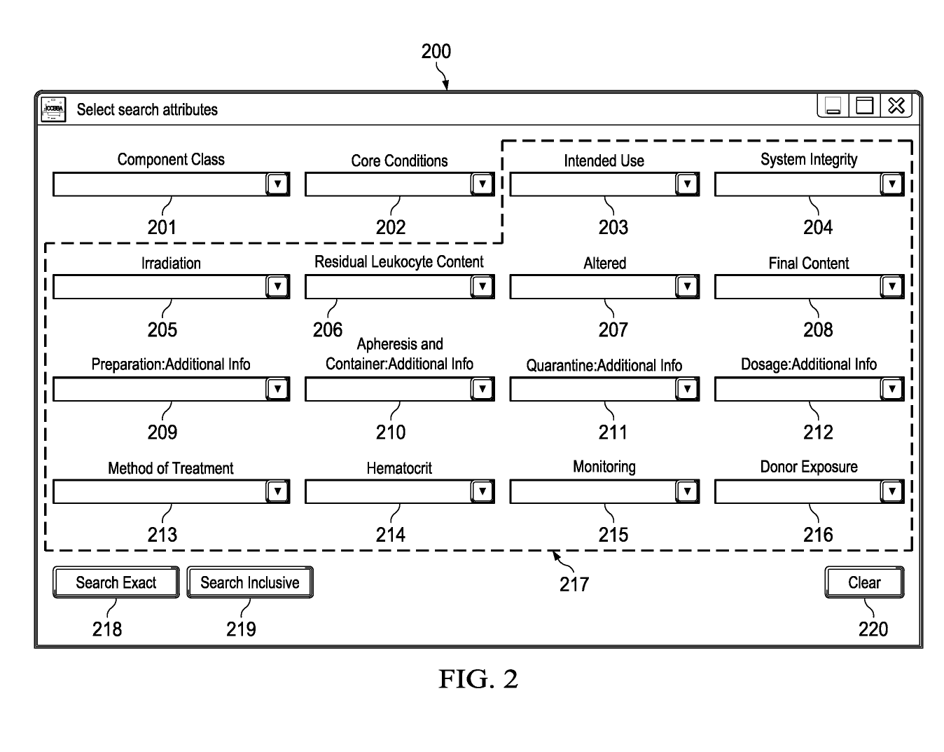

FIG. 2 illustrates an exemplary search of Blood Products. In this type of search, there are multiple fields that users need to select from in order to find the appropriate code. These data fields include categories such as Component Class, Modifiers, Core Conditions, and Variable Attributes.

One example of how the Product look up software works is depicted in FIG. 2. In this example, Component Class 201, which is a Modifier and a Class, is Washed RED BLOOD CELLS. The Core Conditions 202 contain Anticoagulant/Volume/Storage Values and the Variable Attributes 217 is subdivided into specific categories of Intended Use 203 to Donor Exposure 216 with varying values for each.

In addition, a Search Exact 218 option allows a search for a specific ISBT 128 code from the Product Description Codes Database. Moreover, a Search Inclusive 219 option allows a search of products meeting a minimum search criterion. Further, a Clear 220 option allows a user to clear the data entered.

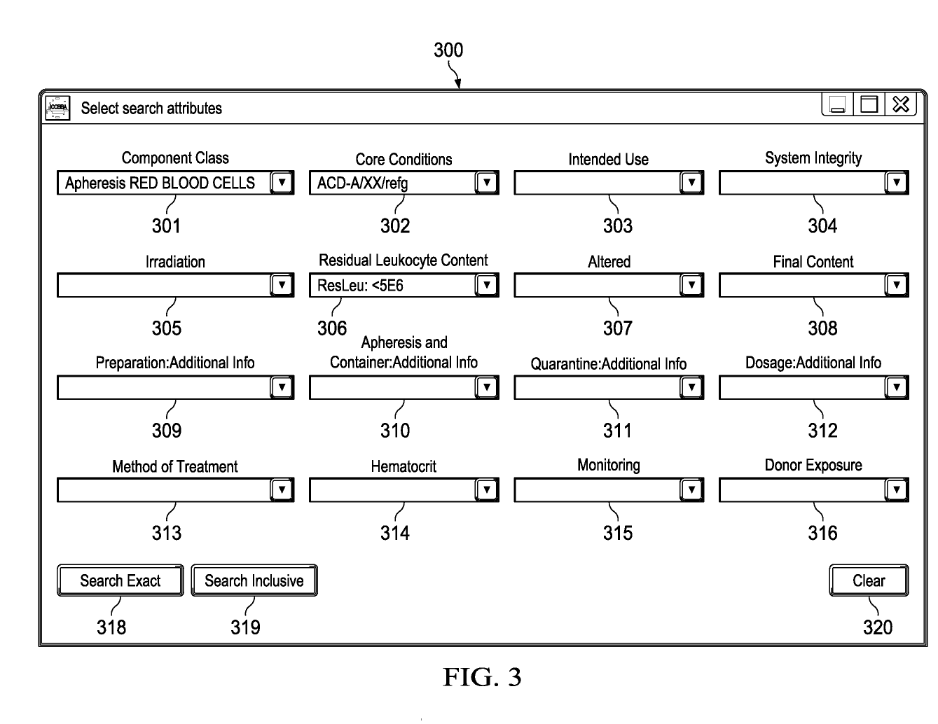

Therefore, as depicted in FIG. 3, a search for a Product where: Class 301=RED BLOOD CELLS; Modifier 301=Apheresis; Core Conditions 302=ACD-A/XX/refg where ACD-A is the anticoagulant, XX is the Volume and refg is the Storage; Variable Attribute=ResLeu:<5E6 (which is one of the many values for the Variable Attribute Residual Leukocyte Content 306), and click on the Search Inclusive 319 option is illustrated.

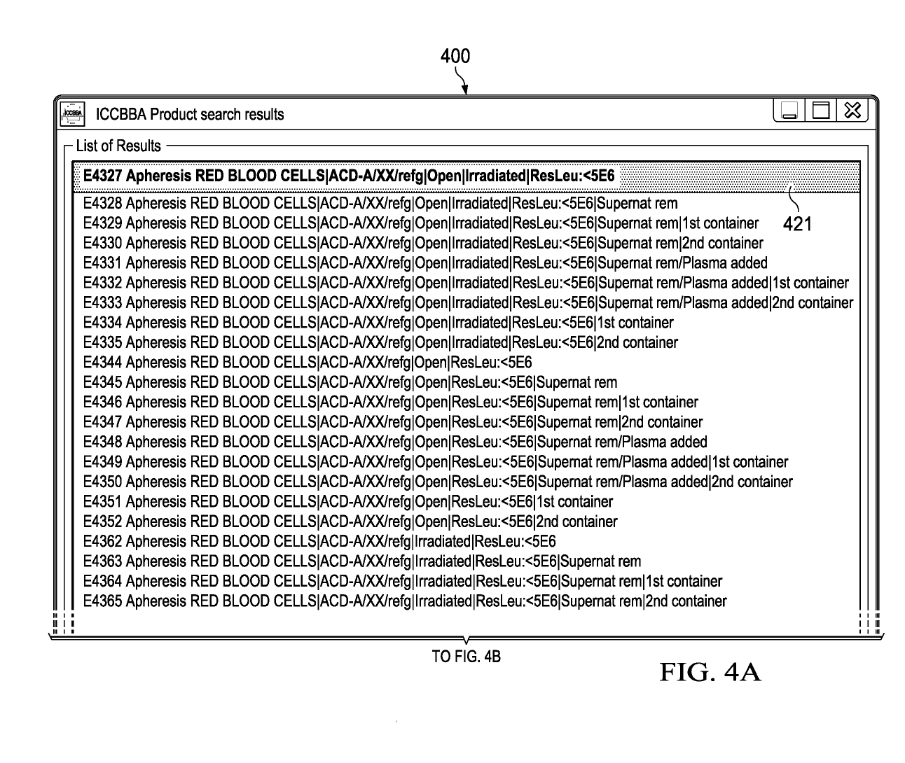

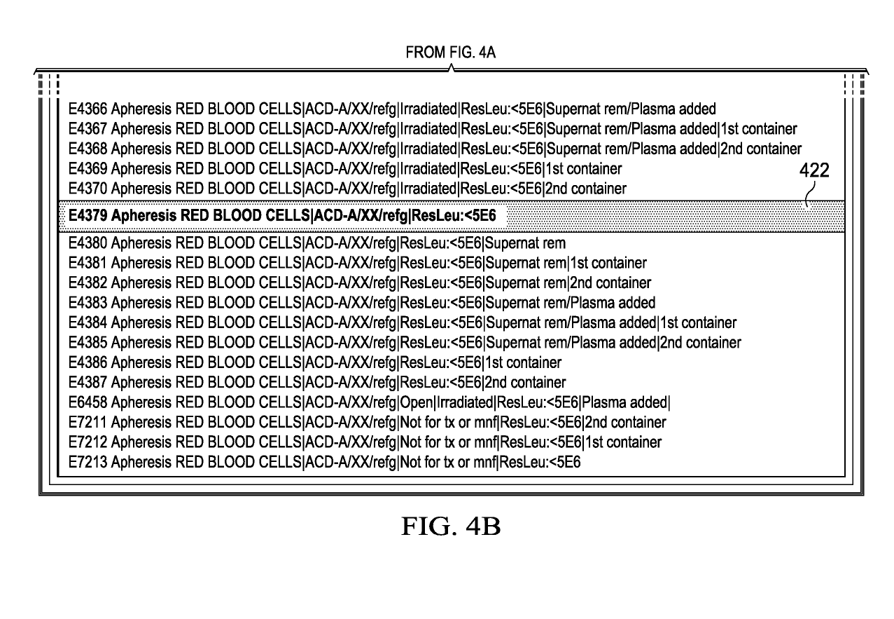

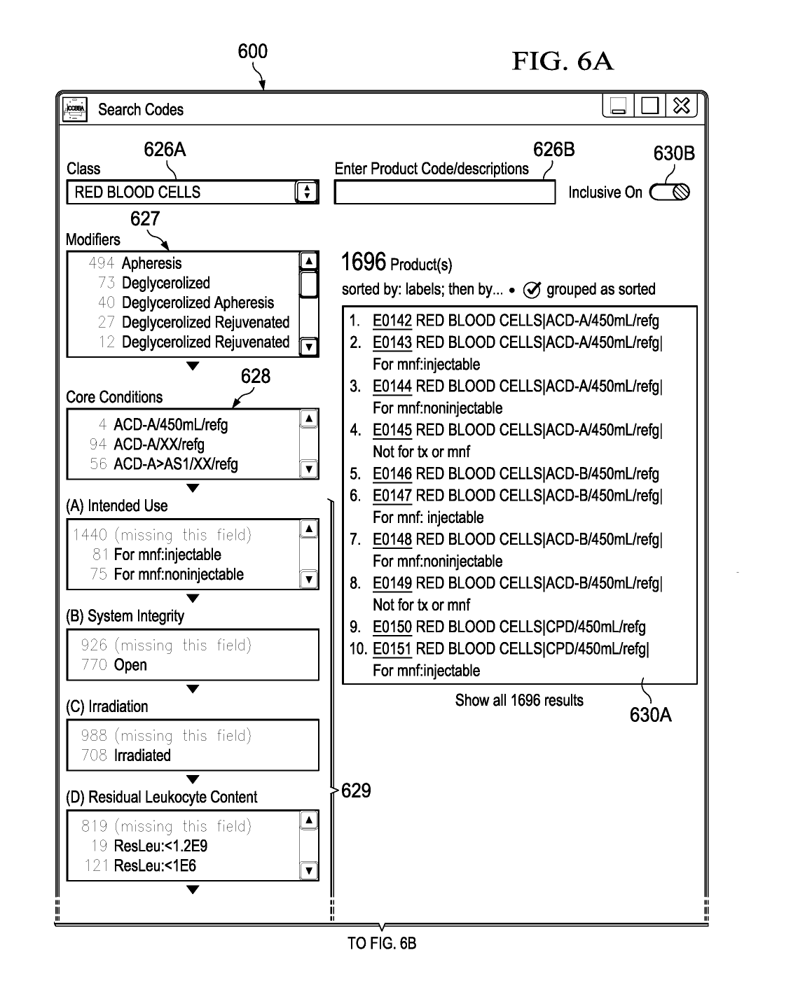

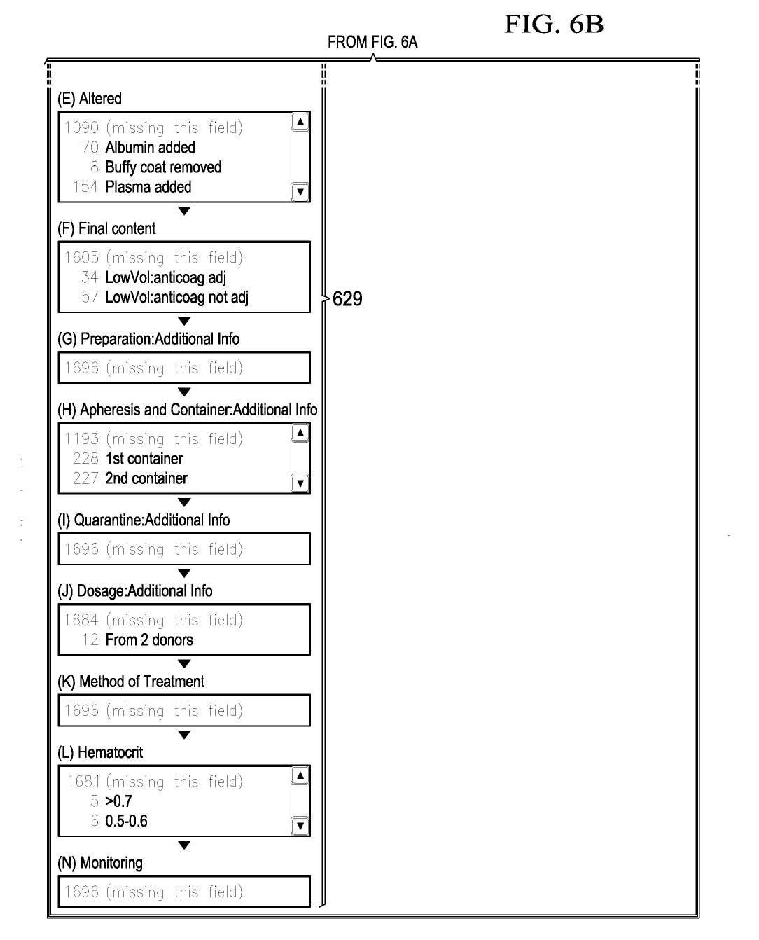

Now turning to FIGS. 4A and 4B, approximately 40 values are returned that meet the minimum requirements of “Apheresis RED BLOOD CELLS|ACD-A/XX/refg|ResLeu:<E56”.

Users may then select codes for products meeting the minimum criteria from the displayed Search results. However, if the user selected the Exact Search 318 option (shown in FIG. 3), the highlighted value 422 would be the only value displayed. If a user wanted to further narrow down the search, for example to a product with additional Attributes such as Irradiated and Open Attributes which is the highlighted value 421, the specific values “Irradiated” and “Open” will need to be entered in the appropriate Variable Attributes field.

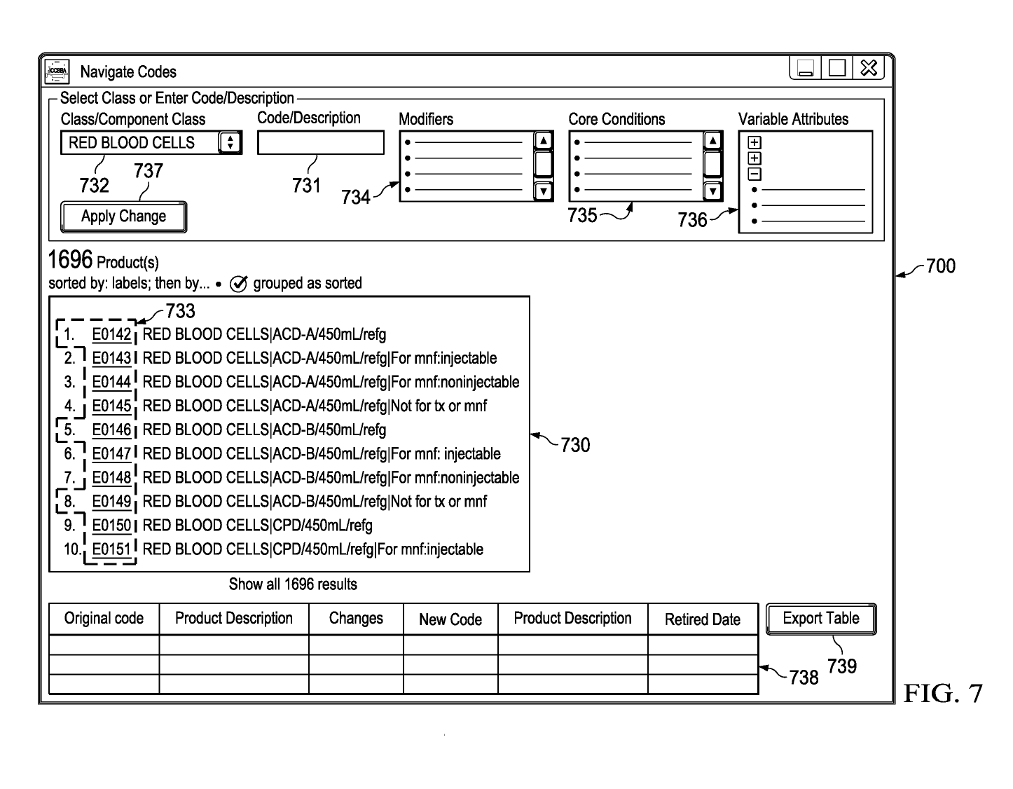

The Product Look Up software also has a feature to Search on ICCBBA Code and the ISBT product description as displayed in FIG. 5. In this example, when the User enters the ISBT 128 Code of “E4379” in the ICCBBA Product Code field 523 and clicks on the Find 524 Icon, a Product Description is displayed in the Search Result 525 field.

Similar search features are also available by several software vendors supporting ISBT 128. Additionally, certain vendors allow the search of the ISBT 128 code and also enable users to print the ISBT 128 labels for the appropriate products.

However, the search of ISBT 128 codes can be daunting due to the number of products codes with very specific values present in the database resulting in a unique ISBT 128 code. Consequently, a unique code is assigned to each specific product. In addition, since the products are categorized by complex relationships between Classes, Modifiers, and Attributes, a new and improved method is needed to display a desired search criterion more efficiently in order to reduce errors and increase efficacy.

Again, while, the ICCBBA and several other software developers provide product look up software in order to search the Product Description Codes database, there is still a need to have a search function which appropriately and/or selectively filters the Modifiers, Attributes, Core Conditions and/or product Class applicable to a particular product Class. The need further extends to mapping the new ISBT 128 Code when changes are applied to the Original code. This will drastically reduce errors and increase efficiency in selecting the appropriate new code for a product when it is modified. In addition, to further increase efficiency, there is a need to find new ISBT 128 codes for multiple products at any single given time resulting when changes are made to the original Products. The resulting data from the search function should also have the ability to be exported into software supporting ISBT 128 as a Spreadsheet, Documents or Databases. This will benefit in creating Standard Operating Procedures (SOPs), importing data into databases of Medical software etc. Moreover, as certain ISBT 128 codes retire, facilities may desire to have an option of, for example, 1 year, to apply the process involved as result of the retired codes. This creates a need to have a mechanism to capture the retire data for an ISBT 128 code when present.

One embodiment of the new and improved method and system for navigating/searching for Blood Transfusion Products will now be described. This embodiment is related to navigating/searching the databases for ISBT 128 codes for specific products.

In accordance with the invention to search ISBT 128 codes, a new and improved software application is provided. Data populated in each of search fields of the application has a parent-child relationship, thus filtering out unrelated data. The data search includes all ISBT 128 codes including Blood Products, Cellular Therapy Products, Organs, and Tissues. The application includes and not limited to technologies such as Internet software, software downloaded locally, mobile applications etc.

In accordance with one other aspect of the invention, original ISBT 128 codes can be mapped to new ISBT 128 codes when changes are made to the original ISBT 128 code. Additionally, codes can be mapped for one or more codes at a given time thus increasing the efficiency of the navigating of codes to the new ISBT 128 codes in a manner that reduces the errors. Mapping the codes of original product to new product codes aids in reducing errors when products change requiring the defining and labeling of the product with a new ISBT 128 code.

In accordance with an additional aspect of the invention, the retired data of a code is displayed. The retired code date notification can be done in several ways including alerts of frequently used codes. The codes that are searched may also be exported into, but not limited to, spreadsheets or databases to be used for populating ISBT 128 related software applications, creating SOPs, etc.

FIGS. 6A and 6B illustrate the concept for the new application to search ISBT 128 codes. First, the User selects the desired Class/Component class 626A of an ISBT 128 code. The search may also begin with the entry of ISBT 128 Code/description 626B.

Modifiers displayed in 627 are specific to the Class/Component Class selected. User may select the appropriate Modifier(s). In addition, as stated earlier, Core Conditions 628 have parent-child relationships and thus unrelated data is not displayed.

A selection of variable attributes 629 is also displayed. Individual values under each group of variable attributes are enabled when data is present. Thus, the user selects the appropriate values to further narrow the search.

The filtered data displays 630A are also shown. Based on whether the user selects inclusive data or exact data, by making the appropriate selection 630B, the data displayed 630A is inclusive or exact.

FIG. 7 illustrates the aspect of the invention of mapping or navigating the original ISBT 128 code to the new ISBT 128 code when changes are made to the original code. Changes made to the original code define the product by a new ISBT 128 code and may require relabeling of the product with the new ISBT 128 code. Mapping the codes can be daunting and lead to errors with the other current systems.

In accordance with the current embodiment, the user may enter the original ISBT Code/Product Description 731, which displays the appropriate product codes/product description 730. The user may also select the Class/Component Class 732, which populates the Product codes/Product description 730 from which the user may select the Original Product. The system populates by selectively filtering the desired Modifiers 734, Core Conditions 735, and Attributes 736. Further, the selection of Core Conditions may be enabled and or limited based on the selection of the Modifiers 734. When selecting the apply changes Icon 737, which indicates all required changes have been entered, the appropriate data is displayed, but not limited to, in the format 738 shown. Additionally, any retired data 740 is also displayed in the format, but not limited to, shown in FIG. 7.

In accordance to the increase efficacy of the present invention, as stated before, data may also be exported to, by clicking on the export data icon 739, but not limited to, spreadsheets, databases, etc. Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

We claim:

1. A system for searching for unique descriptors for a plurality of blood products, the system comprising:
a database of blood products including a unique descriptor for each blood product;
a searching interface to identify the unique descriptor for a desired blood product.

2. The system of claim 1, further including search criteria categories for the desired blood product that result in an ISBT 128 code with a parent-child relationship enhancing the search ability by reducing errors.

3. The system of claim 2 wherein the search criteria categories is supported by Class, Modifiers, and Attributes that have appropriate data populated for a user to select from.

4. The system of claim 3 wherein the search criteria categories reduce in selection of inappropriate data and thereby increases efficiency.

5. The system of claim 1 further including mapping/navigating an original ISBT 128 code to a new ISBT 128 code.

6. The system of claim 3 wherein the search criteria categories is applied for finding new codes for more than one original product at a given time thereby increasing efficiency of searching codes.

7. The system of claim 5 wherein new codes are selected thereby limiting data entry errors.

8. The system of claim 7 wherein a plurality of codes are selected at a given time.

9. The system of claim 1 further including displaying retired data with retirement dates.

10. The system of claim 9 further including an effective mechanism of preparing for retiring the data by a given facility within a time frame provided by standard protocols.

11. The system of claim 1 further including a mechanism for exporting data for mapping the original code, changes applied, and a new code, product descriptions and retire dates into tables, databases.
